(19) United States
(12) Patent Application Publication
(10) Pub. No.: US 2015/0025920 A1
(43) Pub. Date: Jan. 22, 2015

(54) CHECK-IN REDUCED CARRY ON BAGGAGE SYSTEM AND OTHER BOARDING PROCESS ENHANCEMENTS

(71) Applicant: Alaska Airlines, Inc., Seattle, WA (US)

(72) Inventors: Sandra Lynn Stelling, Shoreline, WA (US); Brian Wendell Robey, Renton, WA (US); Jerry Allen Tolzman, Shoreline, WA (US); HerngChuan Michael Yu, Mercer Island, WA (US); Van Gia Bao, Des Moines, WA (US); Benjamin Michael Casad, San Diego, CA (US); Marshall Scott Allen, SeaTac, WA (US); Zachary Allen Anderson, Auburn, WA (US); Brandon Murray Cooper, Tacoma, WA (US)

(73) Assignee: ALASKA AIRLINES, INC., Seattle, WA (US)

(21) Appl. No.: 14/334,589

(22) Filed: Jul. 17, 2014

Related U.S. Application Data
(60) Provisional application No. 61/847,470, filed on Jul. 17, 2013.

(51) Int. Cl. G06Q 10/02

(52) U.S. Cl. CPC G06Q 10/02
USPC 705/5

(57) ABSTRACT

A method for improving boarding of passengers and baggage onto a flight, comprises, at a predetermined time before the scheduled departure of the flight, determining an eligible carry-on baggage items count of carry-on baggage items eligible for treatment as checked baggage items. The eligible carry-on baggage items count is based on predetermined criteria comprising at least one of an aircraft type for the flight, a passenger load factor for the flight and carrier historical data relevant to the flight. If the eligible carry-on items count is greater than zero, then an offer to a passenger on the flight to have the passenger's carry-on baggage item treated as a checked baggage item is communicated, and the passenger's communication in response to the offer is received. For each accepted offer, decrementing the eligible carry-on items count.

### CROSS REFERENCE TO RELATED APPLICATION

This application claims the benefit of U.S. Provisional Patent Application No. 61/847,470, filed Jul. 17, 2013, which is hereby incorporated by reference.

### FIELD

This application relates to boarding processes for boarding passengers onto vehicles, and particularly to passenger boarding for commercial airline flights.

### BACKGROUND

Increases in passenger volume, security requirements and carrier cost cutting have made airline travel more demanding to passengers and the work forces that serve them throughout the process. One area where improvement is necessary concerns boarding, especially since current boarding processes consume too much time, require too much intervention by gate agents and other staff, require redundant actions and still leave passengers with uncertainty and demanding greater satisfaction.

These concerns extend to passenger baggage, and particularly as to whether a planned carry-on baggage item will be accommodated in the available space on the aircraft or whether it will have to be re-designated as checked baggage during the boarding process. Passengers who are faced with having to check a baggage item at the last minute need to take time to repack items to ensure that essentials (such as medication, as just one example) are immediately available in case a checked bag is lost over the course of the passenger's travel. When carrier's attempt to incent passengers to check baggage items at the last minute instead of carrying them on, staff time is required as the number of offers to be made is continually recalculated.

### SUMMARY

Described below are various enhancements to the boarding process intended to address the shortcomings of current practices.

According to one implementation, there is a method for improving boarding of passengers and baggage onto a flight. At a predetermined time before the scheduled departure of the flight, an eligible carry-on baggage items count of carry-on baggage items eligible for treatment as checked baggage items is determined. The eligible carry-on baggage items count is based on predetermined criteria comprising at least one of an aircraft type for the flight, a passenger load factor for the flight and carrier historical data relevant to the flight. If the eligible carry-on items count is greater than zero, then an offer to a passenger on the flight to have the passenger's carry-on baggage item treated as a checked baggage item is communicated, and the passenger's communication in response to the offer is received. For each accepted offer, eligible carry-on items count is decremented.

The offer to the passenger can be communicated during the passenger check-in procedure. The passenger check-in procedure can be carried out over the carrier's web site, or at a carrier kiosk, as just two examples. The predetermined time at which the eligible carry-on baggage items count is determined and offers are made can be at about 24 hours before the scheduled time of the flight.

The eligible carry-on baggage count can be based on at least a load factor for the flight, wherein the load factor is defined as a number of passengers checked in for the flight divided by the number of passenger seats available for the flight. The carrier historical data relevant to the flight can comprise data for passenger carry-on luggage volumes for past passenger traffic between the same city pairs as the present flight. The aircraft type for the flight can comprise carry-on baggage items capacity information, such as a number of carry-on baggage item storage bins and volumes for the bins.

The method can include determining whether a passenger is eligible to receive the offer based on the passenger's status, such as whether the passenger is a member of a carrier loyalty (or mileage) program.

According to another implementation, a method of scheduling boarding of passengers on a vehicle comprises dividing the vehicle into a multiple seating regions, setting a target number of passengers for each boarding group, rank ordering passenger seat assignments within each of the multiple seating regions according to a passenger priority corresponding to each respective passenger and set according to at least one predetermined criteria and assigning the rank ordered passengers to boarding groups in approximately equal numbers, thereby dispersing passengers of a same boarding group throughout the multiple seating regions of the aircraft.

The predetermined criteria on which the passenger priority is determined can comprise at least one of a special service designation (e.g., unaccompanied minors, disabled), membership in a passenger loyalty program for a carrier that operates the vehicle, a membership tier within the passenger loyalty program for the carrier that operates the vehicle, membership in another carrier's passenger loyalty program, use of a carrier-sponsored or other specific credit card and use of the carrier's website to complete the check in procedure, as some examples.

Additional criteria upon which priority and/or a separate intragroup priority can be assigned comprise at least one of a check-in time, a passenger loyalty program tier, a ticket price paid by the passenger, a designation indicating a source from which the ticket was purchased and a mode by which the passenger checked in for the flight, as some examples.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flow chart of a method for reducing carry-on baggage by offering passengers during the check-in process the opportunity to check their carry-on items as space allows on the flight.

FIG. 2 is a diagram showing a boarding system with communications links to passengers and implementing the reduced carry-on baggage methods shown in FIG. 1.

FIG. 3 is a table showing some of the criteria used to determine an eligible carry-on baggage item count.

FIG. 4 is a flow chart of a method for assigning passengers to boarding groups based on passenger priority.

FIG. 5 is a diagram showing a boarding group plan and how passengers of different priority are related to each other.

FIG. 6 is a schematic plan view of the passenger compartment of an aircraft showing the different seating regions and seat assignments for passengers among the various boarding groups.

FIG. 7 is a schematic representation of a new visual message to accompany a new silent or noise reduced boarding process.

### DETAILED DESCRIPTION

According to a first implementation, a new boarding process provides for offering select passengers an opportunity to designate baggage items as checked baggage items instead of as carry-on baggage items as a part of the check-in process and on as-needed basis. In general, this opportunity begins well in advance of boarding, e.g., at 24 hours before the departure time for the flight. The offer is made to passengers as they check-in, such as over the internet, but it also possible to extend the offer via a kiosk or agent check-in procedure. The offer may to allow baggage items to be checked may be made without a fee, with a reduced fee (compared to the regular checked baggage fee) or with the same fee as the regular checked baggage fee. In general, each offer made would be limited to a single baggage item per passenger, but the program could be adopted as needed and in special situations to allow multiple items per passenger to be checked.

The as-needed basis for making offers to the passengers can be based on a number of factors. According to one approach, the carrier determines the anticipated volume of carry-on baggage items based on one or more criteria, including the type of aircraft for the flight, the load factor for the flight (defined as the number of passengers divided by the number of available seats), and historical data. Historical data can include, e.g., actual data on the number of carry-on items transported on past flights, which varies according to destination, time of year and other factors, but has been discovered to be trackable by specifying the “city pair” for the flight (i.e., the originating and destination cities). As one example, city pairs corresponding to long-stay leisure destinations typically have a much lower volume of carry-on baggage items than city pairs corresponding to short-stay business destinations. From the evaluation of the criteria, an eligible carry-on baggage item count is determined This count represents the desired number of carry-on baggage items that the carrier would desire to have to re-designated as checked baggage items in an effort to ensure sufficient space for remaining carry-on items and keep boarding time to a minimum. Aircraft may have space to accommodate one typical carry-on baggage item per passenger for only about 50-60% of passengers. Offers are made to passengers on a first available basis, or on some other basis, such as to passengers who are members of the carrier's loyalty (or mileage) program(s). For each offer that is accepted, the count is decreased and tracked until it reaches zero and no further offers are made.

As a result, gate agents need not spend time making repeated public address announcements with similar offers to passengers en masse during boarding, which takes their time away from other activities and makes the boarding area environment unpleasant. Also, under the new approach, participating passengers need not carry their qualifying baggage items through security checkpoints (rather, they are directed to drop them off like regular checked baggage items). Participating passengers avoid the need to open their baggage items and repack them. Other passengers who prepaid to check bags are not reminded of the offer for free checking of bags.

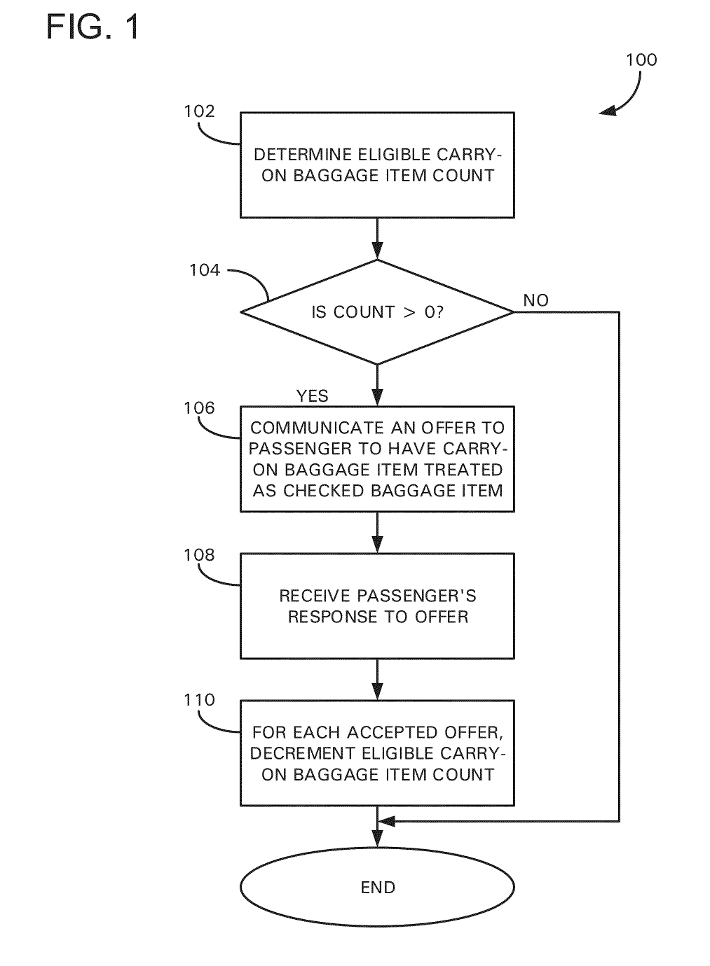

A representative method implementation 100 is shown in FIG. 1. In step 102, an eligible carry-on baggage item count is determined. In step 104, a decision is made whether the eligible carry-on item count has reached zero. If so, the method is ended. If not, the method proceeds to step 106, in which an offer is communicated to a passenger, generally during the check-in procedure, for having the passenger's carry-on baggage item treated as a checked baggage item. In step 108, the passenger's response to the offer is received, such as through a carrier website, at a kiosk, an agent or other similar channel. In step 110, the count is decremented for each accepted offer. The process is repeated until enough offers are accepted that the eligible carry-on count reaches zero. In some implementations, the count is dynamically adjusted to reflect last minute changes such as passengers who miss flights, etc.

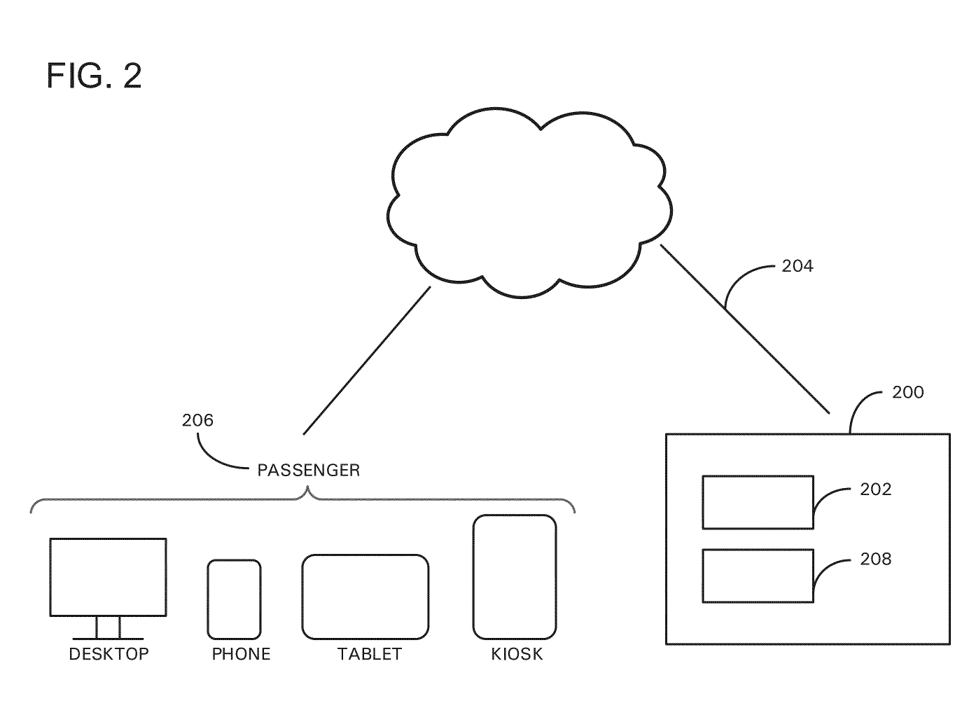

FIG. 2 is a diagram showing a typical boarding system 200 used to carry out a carry on reduced boarding procedure. The system 200 is typically operated by the carrier for the flight, but other arrangements are possible. The system is implemented using one or more computers and comprises a memory 202 and a processor 208. The system 202 has a communications link 204 with passengers 206 or an agent of the carrier. The communications link 204 may be based on the internet or other public or private network. A telephone link can also be used.

As shown, the customer may interface with the system 200 via the communications link 204 using a computer, a smart phone, a tablet, or a kiosk, or in person or by telephone via the agent using any of the described devices or a carrier-specific device. The system makes the offer and receives the passenger's response via the communications link 204.

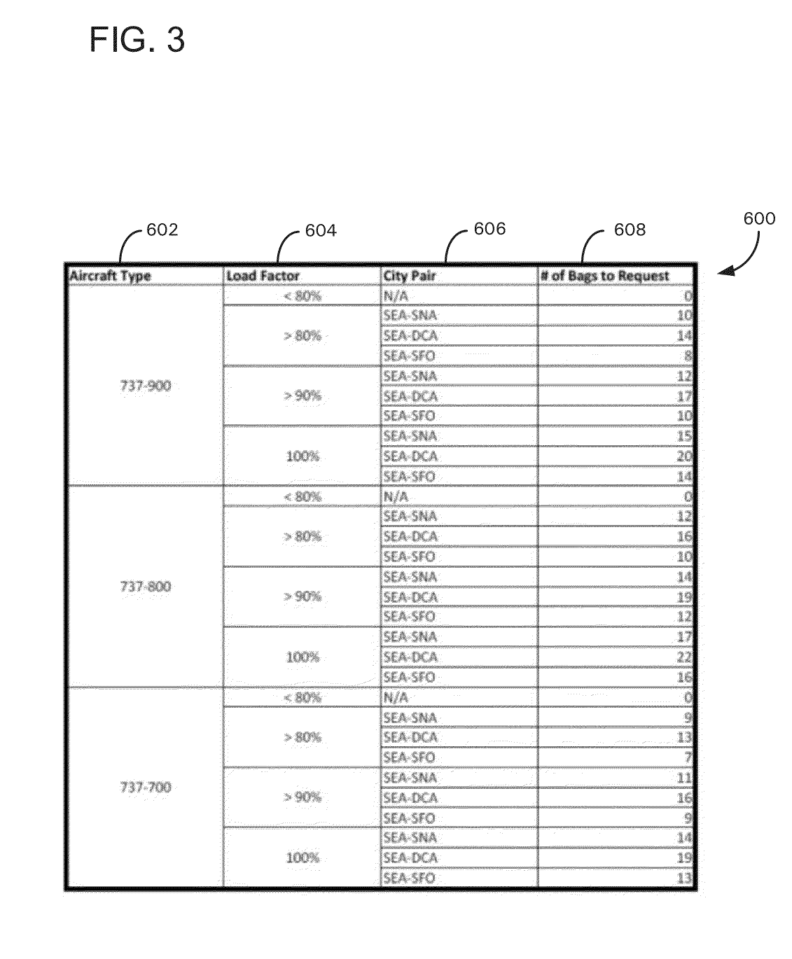

FIG. 3 is a representative table showing exemplary criteria that can be taken into account when calculating an eligible carry-on items count (which is the number shown in column 608 under the heading of “# of bags to request”). The aircraft type column 602 specifies three different types of aircraft, and other data not shown in the table specifies the respective number and volume of available overhead bins and other relevant carry-on baggage item storage area available for each type of aircraft. The load factor 604 column specifies that when fewer than 80% of the seats are anticipated to be occupied, then no offers need to be made. For load factors above 80%, above 90% and at 100%, different counts are specified in column 608. The relationship of the city pair to the resulting count can be seen in column 606, which uses historical data collected by the carrier to modify the count based on past results for flights of the same city pair, thus accounting for different passenger baggage practices based on destination. For example, flights with the city pair “SEA-DCA” (Seattle-Reagan National in Washington, D.C.) generally have a greater volume of carry-on items than flights with the city pair “SEA-SNA” (Seattle-Orange County, Calif.) or with the city pair “SEA-SFO” (Seattle-San Francisco).

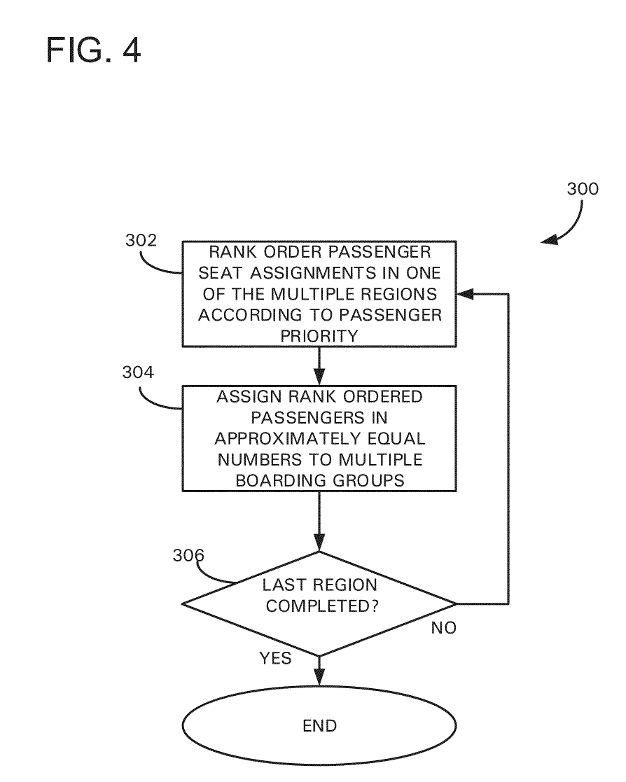

FIG. 4 is a flow chart showing an implementation of a method of assigning priority to passengers for determining boarding order, and in particular to recognizing a priority designation among passengers having seats in a same physical area or region of the aircraft. By specifying at least this priority, which may be a second or even a third level of priority, the carrier can exercise more control over seating assignments. For example, for passengers assigned to Boarding Group A, which presumably contains more passengers with higher priority than other boarding groups, the seat assignment program can ensure that the available seats offered to these passengers are dispersed among the different physical regions of the aircraft. As a result, Boarding Group A passengers will not be clustered in a single region and tending to impede each other while they are boarding and stowing their carry-on baggage items, which causes delays in boarding. In addition, the carrier can show more appreciation for different status levels earned by a passenger, such as membership in enhanced tiers of customer loyalty or frequent flyer programs.

In advance of the flight, e.g., about 24 hours before the flight, the seat selections that passengers have made are accessed by the carrier to determine an inventory of available seats. For those passengers who have not selected seats, the carrier assigns them seats. At this point, the carrier has a preliminary determination of how confirmed passengers need to be accommodated and can take preliminary steps to divide the passengers in some fashion so as to make the boarding process run smoothly (subject, of course, to relatively minor changes in overall numbers up until departure). According to one implementation, the passengers are divided into boarding groups, and the passengers assigned to each boarding group are dispersed throughout the multiple regions of the plane.

To do so, the carrier ranks all of the confirmed passengers within each of the multiple physical regions of the aircraft according to a passenger priority. In the example, the carrier considers the aircraft to have four regions: front, middle front, middle back and back. (It is, of course, possible to use a fewer or greater number of regions depending up on the particular circumstances, including the size and physical layout of the aircraft.) In the example, the carrier targets each boarding group to have a size of 20 passengers. (Boarding groups of other sizes can also be used, depending upon the boarding conditions.) Accordingly, using an example of the Front region of the aircraft, once the passengers having seat assignments in the Front region are ranked according to their priority, then the first five passengers are assigned to Boarding Group A, the next five are assigned to Boarding Group B, the next five to Boarding Group C, and so on until all Front region passengers have been assigned to a Boarding Group. The Front region may comprise 20-40 passengers, depending upon the size of the aircraft and the passenger volume on the flight. This process is carried out for each of the multiple regions. As a result, it should be expected that there are about five passengers of each full boarding group (20 passengers) with seat assignments in each one of the four regions (5×4=20).

A program flow according to one implementation is shown in FIG. 4 for a program 300. In step 302, passenger seat assignments for a first of the regions of the aircraft are rank ordered according to passenger priority. In a step 304, the carrier assigns the rank ordered passengers in approximately equal numbers to multiple boarding group. As indicated at the decision 306, the process is repeated until each passenger within each of the multiple regions has been assigned to one of the boarding groups. Boarding then proceeds in order boarding group order as carried out by carrier's gate agents. The program 300 can be carried out in the same environment shown in FIG. 2.

As described in more detail below, the predetermined criteria on which the passenger priority is determined can comprise at least one of a special service designation, membership in a passenger loyalty program for a carrier that operates the vehicle, a membership tier within the passenger loyalty program for the carrier that operates the vehicle, membership in another carrier's passenger loyalty program and use of the carrier's website to complete the check in procedure, as some examples.

Additional criteria can be used to assign priority, including priority among passengers having the same first or primary priority level (e.g., both passengers are Gold 75 loyalty plan members.) Such additional criteria can include at least one of a check-in time, a passenger loyalty program tier (if different), a ticket price paid by the passenger, a designation indicating a source from which the ticket was purchased and a mode by which the passenger checked in for the flight, as some examples.

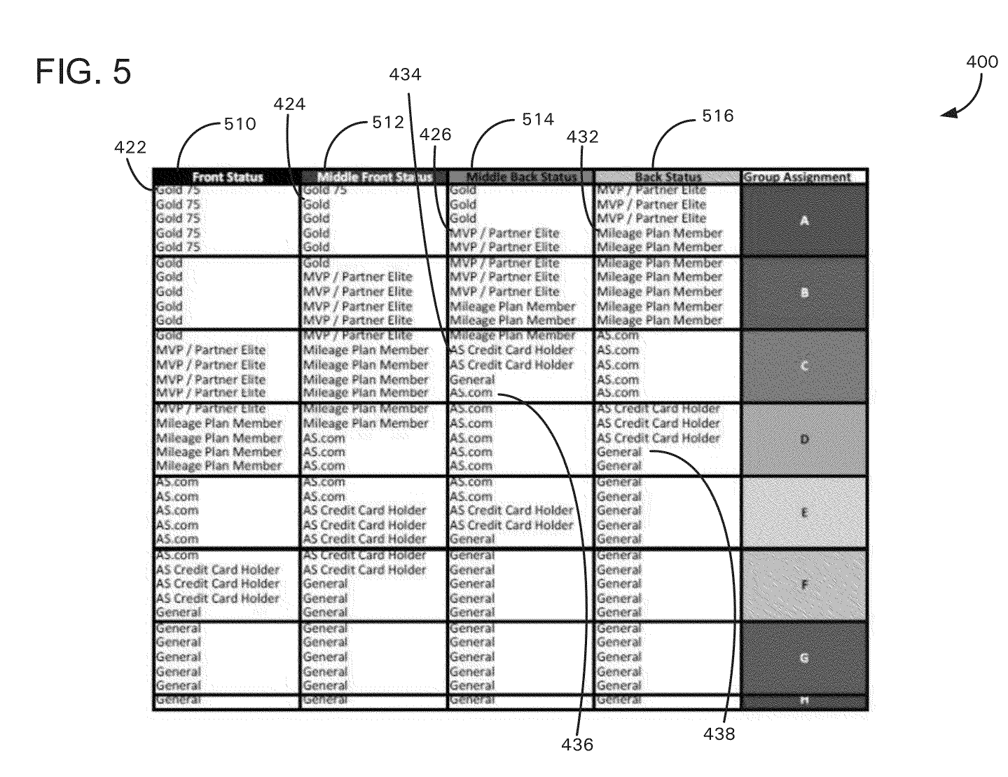

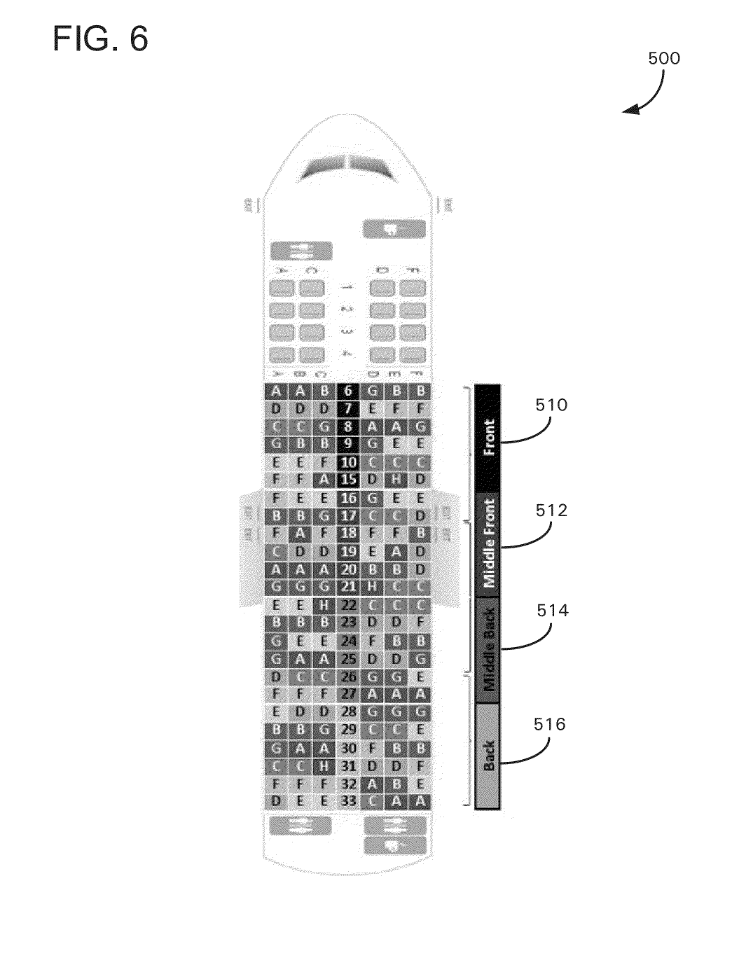

FIG. 5 is a diagram showing a boarding group assignment 400 for a full coach section of a flight, and FIG. 6 is a corresponding seating plan for the flight based on a plan view of a representative aircraft. As shown in FIGS. 4 and 5, the aircraft is considered to have four regions: front 510, middle front 512, middle back 514 and back 516. FIG. 5 shows the resulting boarding group assignments made for passengers relative to passenger priority. Passenger priority in this example is based on a number of factors, including membership in carrier loyalty (mileage plans) and qualification for enhanced tiers of these plans, which in this example are ranked as from highest to lowest as follows: Gold 75 (422), Gold (424), MVP/Partner Elite (426) and Mileage Plan Member (432). Next in the succession of descending priority are AS Credit Card (434) passengers who hold a specific credit card (such as one sponsored by the carrier), AS.com (436) passengers who purchased their tickets and/or checked in for the flight via the carriers' website and finally General (438) passengers, who in this example do not have priority relative to any other class of passengers. As can be seen, the relatively few (6) highest priority Gold 75 passengers have seats in Front or Middle Front regions, and all are in the first boarding group to board, i.e., Boarding Group A. The next highest tier, Gold, has passengers in Boarding Group A as well as in Boarding Group B and Boarding Group C. Boarding Groups G and H in this example have only General passengers.

As shown in FIG. 6, this approach effectively disperses passengers of the same boarding group to different regions 510, 512, 514, 516 of the aircraft, while still respecting passenger status and applying priority in ways to promote fairness and increase boarding process speed.

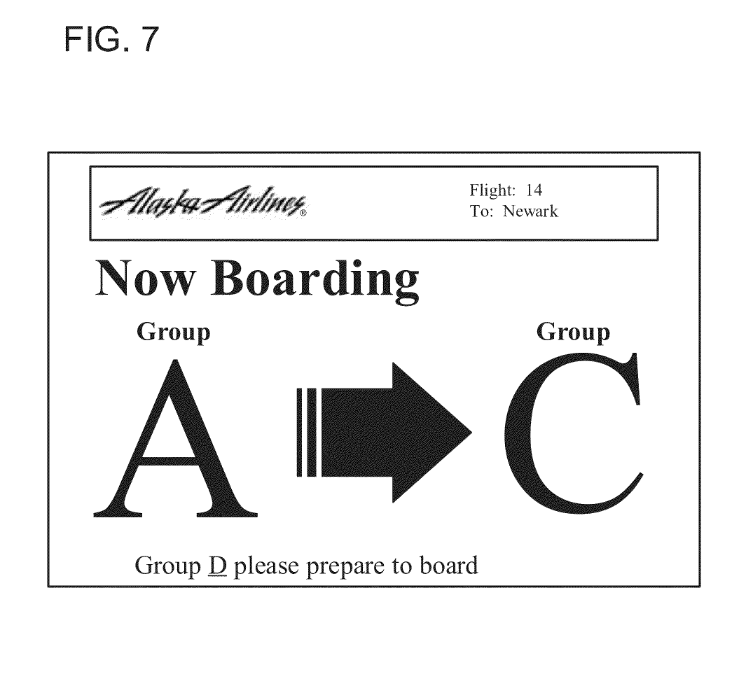

Some additional features of new boarding process enhancements are described below. These new enhancements reduce customer stress during the boarding process, limit the length of the boarding line, reduce the amount of time spent standing in line, reduce the “back-up” which occurs on the jet bridge during boarding, allow priority to given not only by elite status, but by ticket price, purchase location (e.g. alaskaair.com vs. Orbitz) or payment method (e.g. Alaska Airlines Visa card vs. standard credit card)(as described above), reduce the number and length of public address announcements, create new “visual aids” to ensure a smooth boarding flow (see FIG. 7), and introduce “text message” boarding to the boarding process.

In a text message boarding enhancement, during purchase at the carrier website or during Web Check-in, Kiosk Check-in or Agent Check-in, customers may choose to provide their mobile phone numbers to receive text messages when their respective groups are ready to board. Upon providing a mobile phone number, each participating customer receives a text confirming that he or she is signed up, along with a reminder of the carry-on baggage policy. During the boarding process, when the agent updates the electronic boarding sign indicating which group is boarding, a text is automatically sent to participating customers. A representative new “silent” boarding display is shown in FIG. 7. The text message includes a welcome to the flight message and an indication that the customer's group is boarding. At the conclusion of boarding, the customer receives a final text with a “thank you and enjoy the flight” message. Text message boarding, along with new visual display information, will allow the boarding process to be completed “silently” or at least with far fewer announcements.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for improving boarding of passengers and baggage onto a flight, comprising:
at a predetermined time before the scheduled departure of the flight, determining an eligible carry-on baggage items count of carry-on baggage items eligible for treatment as checked baggage items based on predetermined criteria comprising at least one of an aircraft type for the flight, a passenger load factor for the flight and carrier historical data relevant to the flight;
if the eligible carry-on items count is greater than zero, communicating an offer to a passenger on the flight to have the passenger's carry-on baggage item treated as a checked baggage item;
receiving the passenger's communication in response to the offer; and
for each accepted offer, decrementing the eligible carry-on items count.

2. The method of claim 1, wherein the load factor is defined as a number of passengers checked in for the flight divided by the number of passenger seats available for the flight.

3. The method of claim 1, wherein communicating the offer to the passenger is carried out during the passenger check-in procedure.

4. The method of claim 3, wherein the passenger check-in procedure is carried out over the carrier's web site.

5. The method of claim 1, wherein the predetermined time before the scheduled flight is about 24 hours.

6. The method of claim 1, wherein carrier historical data relevant to the flight comprises data for passenger carry-on luggage volumes for past passenger traffic between the same city pairs as the present flight.

7. The method of claim 1, wherein the aircraft type for the flight comprises carry-on baggage items capacity information.

8. The method of claim 7, wherein the carry-on baggage items capacity information comprises a number of carry-on baggage item storage bins and volumes for the bins.

9. The method of claim 1, further comprising determining whether a passenger is eligible to receive the offer based on the passenger's status.

10. One or more computer-readable media storing computer-executable instructions for causing a computing system programmed thereby to perform a method comprising:
at a predetermined time before the scheduled departure of the flight, determining an eligible carry-on baggage items count of carry-on baggage items eligible for treatment as checked baggage items based on predetermined criteria comprising at least one of an aircraft type for the flight, a passenger load factor for the flight and carrier historical data relevant to the flight;
if the eligible carry-on items count is greater than zero, communicating an offer to a passenger on the flight to have the passenger's carry-on baggage item treated as a checked baggage item;
receiving the passenger's communication in response to the offer; and
for each accepted offer, decrementing the eligible carry-on items count.

11. A boarding system for carrying out a boarding process of boarding passengers and baggage for an aircraft flight, comprising:
a memory;
a network communications link via over which communications between passengers and a carrier for the flight are exchanged;
a processor programmed to determine an eligible carry-on baggage items count of carry-on baggage items eligible for treatment as checked baggage items based on predetermined criteria comprising at least one of an aircraft type for the flight, a passenger load factor for the flight and carrier historical data relevant to the flight, wherein at least the carrier historical data is accessed from the memory;
wherein if the eligible carry-on items count is greater than zero, the processor initiates a communication to a passenger on the flight over the network communications link to have the passenger's carry-on baggage item treated as a checked baggage item, receives the passenger's communication in response to the offer, and, for each accepted offer, decrements the eligible carry-on items count.

12. The boarding system of claim 11, wherein the communications between passengers and a carrier for the flight are exchanged via a carrier website during a passenger check in procedure.

13. The boarding system of claim 12, wherein the communications between passengers and a carrier for the flight are exchanged via a carrier kiosk during a passenger check in procedure.

14. A method of scheduling boarding of passengers on a vehicle, comprising:
dividing the vehicle into a multiple seating regions;
setting a target number of passengers for each boarding group;
rank ordering passenger seat assignments within each of the multiple seating regions according to a passenger priority corresponding to each respective passenger and set according to at least one predetermined criteria; and
assign the rank ordered passengers to boarding groups in approximately equal numbers, thereby dispersing passengers of a same boarding group throughout the multiple seating regions of the aircraft.

15. The method of claim 14, wherein the predetermined criteria on which the passenger priority is determined comprise at least one of a special service designation, membership in a passenger loyalty program for a carrier that operates the vehicle, a membership tier within the passenger loyalty program for the carrier that operates the vehicle, membership in another carrier's passenger loyalty program, status as a holder of a credit card and use of the carrier's website to complete the check in procedure.

16. The method of claim 14, wherein a further priority determination is made based upon at least one of a check-in time, a passenger loyalty program tier, a ticket price paid by the passenger, a designation indicating a source from which the ticket was purchased and a mode by which the passenger checked in for the flight.

17. The method of claim 14, wherein each boarding group is configured to have approximately 20 passengers.

18. The method of claim 14, wherein the multiple seating regions comprise of a front region of an aircraft, a middle front region of the aircraft, a middle back region of the aircraft and a back region of the aircraft.

19. The method of claim 14, wherein at least a first boarding group has seat assignments in four designated physical regions consisting of a front region of an aircraft, a middle front region of the aircraft, a middle back region of the aircraft and a back region of the aircraft.

20. The method of claim 14, further comprising carrying out a boarding process in the order of the assigned boarding groups.
